(19) United States
(12) Patent Application Publication
(10) Pub. No.: US 2026/0279940 A1
(43) Pub. Date: Sep. 17, 2026

(54) CHARGING AND DISCHARGING APPARATUS, METHOD FOR CONTROLLING THE SAME, AND CHARGING AND DISCHARGING SYSTEM INCLUDING THE SAME

(71) Applicant: SK On Co., Ltd., Seoul (KR)

(72) Inventors: Ji Won HONG, Daejeon (KR); Jung Hak YOON, Daejeon (KR); Byung Wook KIM, Daejeon (KR); Woo Seop KIM, Daejeon (KR); Yu Gyung KIM, Daejeon (KR); Jung Uk KIM, Daejeon (KR); Kwae Ha KIM, Daejeon (KR)

(21) Appl. No.: 19/562,761

(22) Filed: Mar. 11, 2026

(30) Foreign Application Priority Data
Mar. 12, 2025 (KR) 10-2025-0032025

(51) Int. Cl. H01M 10/48; H01M 10/42; H01M 10/44; H01M 10/46; H02J 7/00; H02J 7/70

(52) U.S. Cl. CPC H01M 10/482; H01M 10/425; H01M 10/441; H01M 10/443; H01M 10/46; H01M 10/484; H02J 7/70; H02J 7/875; H01M 2010/4271; H01M 2010/4278

(57) ABSTRACT

The present disclosure relates a charging and discharging apparatus includes a charging and discharging channel part electrically connected to a plurality of battery cells, a plurality of jigs configured to support the plurality of battery cells, a temperature sensor part disposed at one side of the plurality of jigs to measure a temperature of an area adjacent to the plurality of battery cells, and a controller configured to control the temperature sensor part, charge or discharge the plurality of battery cells through the charging and discharging channel part, and measure a charging capacity of each battery cell. The controller is configured to calculate a modified charging capacity of each battery cell using a preset equation on the basis of the temperature measured through the temperature sensor part and the calculated charging capacity of each battery cell when each battery cell is charged through the charging and discharging channel part.

### CROSS-REFERENCE TO RELATED PATENT APPLICATION

The present application claims priority under 35 U.S.C. § 119(a) to Korean patent application number 10-2025-0032025 filed on Mar. 12, 2025, in the Ministry of Intellectual Property, the entire disclosure of which is incorporated by reference herein.

### BACKGROUND OF THE INVENTION

### 1. Field

The present disclosure relates to a charging and discharging apparatus, a method for controlling the same, and a charging and discharging system including the same.

### 2. Description of the Related Art

A charging and discharging apparatus performs a function of giving characteristics of secondary batteries (or battery cells) by repeating several charging and discharging processes several times so that an initial battery cell assembled during a production process of the secondary batteries (or battery cells) stores electrical energy.

In the charging and discharging apparatus, a deviation in charging capacity of the battery cells that are chargeable and dischargeable may occur depending on positions at which the charging and the discharging apparatus performs the charging and discharging function. This is because environments (e.g., temperatures) in which the battery cells are disposed varies in the charging and discharging apparatus depending on the positions of the battery cells and positions of a charging and discharging channel. Particularly, since the typical charging and discharging apparatus calculates a charging capacity (or electric capacity) of the battery cell charged through the charging and discharging channel using a single correction equation, the calculated charging capacities of the battery cell charged at different positions may be different from actually measured capacities. Thus, there is a need for a correction method by which the charging capacity of the battery cell is more accurately reflected.

### SUMMARY OF THE INVENTION

According to one aspect of the present disclosure, an object of the present disclosure is to improve manufacturing efficiency of a battery cell.

According to another aspect of the present disclosure, an object of the present disclosure is to reduce a failure rate of a battery cell.

According to further another aspect of the present disclosure, an object of the present disclosure is to improve quality of a battery cell.

The battery cell of the present disclosure may be widely applied in fields of green technologies such as electric vehicles, battery charging stations, solar power generation, wind power generation, etc., which use batteries. In addition, the battery cell of the present disclosure may be used in eco-friendly electric vehicles, hybrid vehicles, etc., which are designed to prevent climate change by suppressing air pollution and greenhouse gas emissions.

A charging and discharging apparatus according to the present disclosure includes: a charging and discharging channel part electrically connected to a plurality of battery cells; a plurality of jigs configured to support the plurality of battery cells; a temperature sensor part disposed at one side of the plurality of jigs to measure a temperature of an area adjacent to the plurality of battery cells; and a controller configured to control the temperature sensor part, charge or discharge the plurality of battery cells through the charging and discharging channel part, and measure a charging capacity of each battery cell, wherein the controller is configured to calculate a modified charging capacity of each battery cell using a preset equation on the basis of the temperature measured through the temperature sensor part and the calculated charging capacity of each battery cell when each battery cell is charged through the charging and discharging channel part.

According to an embodiment, the charging and discharging channel part may include a plurality of charging and discharging channels configured to charge each of a plurality of battery groups, each of which is grouped by a preset number, among the plurality of battery cells.

According to an embodiment, the preset equation may include a plurality of preset equations for each of the plurality of battery groups, wherein at least some of the plurality of preset equations may be different from each other.

According to an embodiment, the temperature sensor part may include a plurality of temperature sensors configured to measure a temperature of an area to which each battery group belongs.

According to an embodiment, the controller may be configured to calculate a modified charging capacity of any battery cell in one battery group by following Equation 1 representing the preset equation.

ACC=A×(capacity)+B×(temperature)+C [Equation 1]

Here, ACC represents a modified charge capacity of any battery cell, C represents a calculated charge capacity of the any battery cell, T represents a temperature of an area to which one of the battery groups belongs, and A, B, and C represent constants.

According to an embodiment, the temperature of the area to which each battery cell belongs may be a mean temperature in a preset measurement section when charging the plurality of battery cells.

A charging and discharging apparatus according to the present disclosure includes: a charging and discharging channel part electrically connected to a plurality of battery cells; a plurality of jigs configured to support the plurality of battery cells; a temperature sensor part disposed at one side of the plurality of jigs to measure a temperature of an area adjacent to the plurality of battery cells; a controller configured to control the temperature sensor part, charge or discharge the plurality of battery cells through the charging and discharging channel part, and calculate a charging capacity of each battery cell; and a server configured to communicate with the controller, wherein the controller is configured to calculate a modified charging capacity of each battery cell using a preset equation on the basis of the temperature measured through the temperature sensor part and the calculated charging capacity of each battery cell when the plurality of battery cells are charged through the charging and discharging channel part so as to transmit the calculated modified charging capacity to the server.

A method for controlling a charging and discharging apparatus according to the present disclosure includes: a process of charging or discharging each of battery cells through a charging and discharging channel part electrically connected to the plurality of battery cells; a process of calculating a charging capacity of each battery cell during the charging of each battery cell through the charging and discharging channel part on the basis of the temperature measured by the temperature sensor part, which is disposed at one side of a plurality of jigs that support the plurality of battery cells to measure a temperature of an area adjacent to the plurality of battery cells; and a process of modifying the charging capacity of each battery cell using a preset equation on the basis of the temperature and the calculated charging capacity of each battery cell.

According to an embodiment, the method may further include, before the process of charging and discharging each battery cell, a process of disposing the plurality of battery cells on the plurality of jigs.

According to an embodiment, the method may further include, after the process of modifying the charging capacity of each battery cell, a process of transmitting the modified charging capacity of each battery cell to a server communicating with the charging and discharging apparatus.

According to an embodiment, the process of modifying the charging capacity of each battery cell may include a process of calculating a modified charging capacity of any battery cell in one battery group using following Equation 2.

ACC=A×(capacity)+B×(temperature)+C [Equation 2]

Here, ACC represents a modified charge capacity of any battery cell, C represents a calculated charge capacity of the any battery cell, T represents a temperature of an area to which one of the battery groups belongs, and A, B, and C represent constants.

According to an embodiment, in the process of modifying the charging capacity of each battery cell, the temperature of the area to which each battery group belongs may be a mean temperature in a preset measurement section when charging the plurality of battery cells.

### BRIEF DESCRIPTION OF THE DRAWINGS

FIG. 1 is a front view illustrating an example of a charging and discharging apparatus according to the present disclosure.

FIG. 2 is a schematic side view illustrating an example of a stage part according to the present disclosure.

FIG. 3 is a control block diagram of the charging and discharging apparatus according to the present disclosure.

FIG. 4 is a view illustrating an example of a charging and discharging system according to the present disclosure.

FIG. 5 is a flowchart illustrating a method for controlling a charging and discharging apparatus according to the present disclosure.

### DETAILED DESCRIPTION

Hereinafter, the present disclosure will be described in detail with reference to the accompanying drawings. However, this is merely illustrative, and the present disclosure is not limited to a specific embodiment illustrated as an example of the present disclosure.

In this disclosure, all the terms “battery”, “secondary battery”, and “cell” refer to a battery cell that is chargeable and dischargeable.

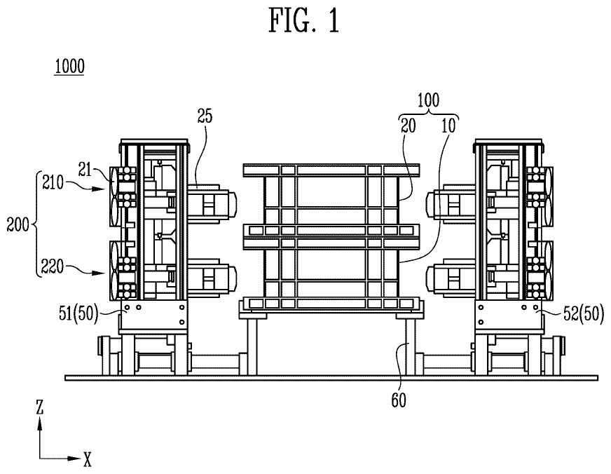

FIG. 1 is a front view illustrating an example of a charging and discharging apparatus according to the present disclosure.

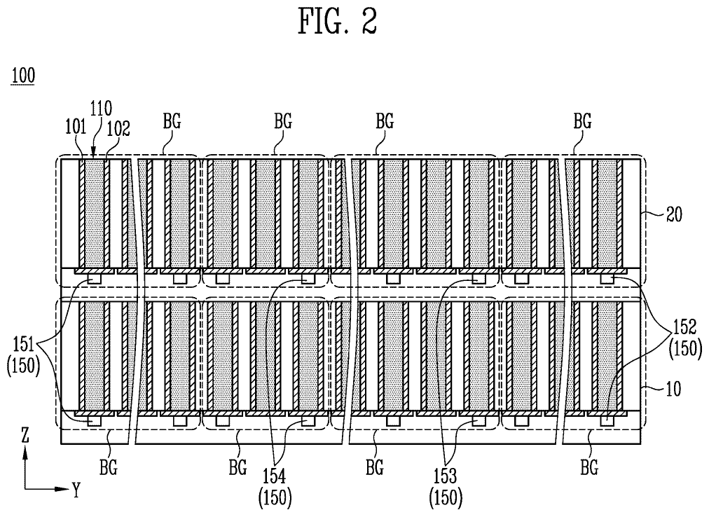

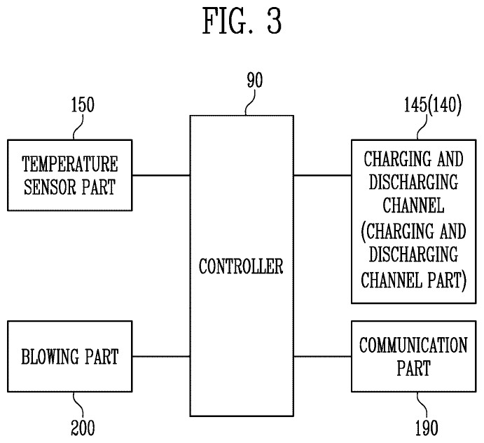

A charging and discharging apparatus 1000 according to the present disclosure may include a stage part 100 that accommodates a plurality of battery cells 110 (see FIG. 2), and a charging and discharging channel part 140 (see FIG. 3) electrically connected to the plurality of battery cells 110 so as to charge/discharge the plurality of battery cells 110, respectively.

In addition, the charging and discharging apparatus 1000 may include a blowing part 200 that blows external air toward the plurality of battery cells 110 with the plurality of battery cells 110 therebetween.

The charging and discharging apparatus 1000 may refer to a battery cell charging and discharging apparatus used for charging and discharging the battery cell.

In this disclosure, the type of the plurality of battery cells 110 has been exemplarily described as a pouch-type, but this is not limited thereto, and the type of the plurality of battery cells 110 may also be a circular or prismatic type.

The stage part 100 may accommodate the plurality of battery cells 110. Referring to FIG. 1, for example, the stage part 100 may have a shape in which the stage part is stacked in two stages in a height direction (Z direction) of the charging and discharging apparatus 1000. That is, the stage part 100 may include a first stage 10 and a second stage 20, which accommodate the plurality of battery cells 110, respectively. Here, the second stage 20 may be disposed above the first stage 10.

However, this is merely an example, and the number of stacked layers of the stage part 100 may be variously modified.

The stage part 100 may be supported by a support part 60.

The blowing part 200 may suction the external air to blow the external air toward the plurality of battery cells 110. The blowing parts 200 may be disposed along a width direction (X direction) of the charging and discharging apparatus 1000 with the stage part 100 therebetween.

The blowing part 200 may suction the external air to blow the external air toward each stage of the stage part 100. For example, referring to FIG. 1, the blowing part 200 may be provided in plurality, and the plurality of blowing parts 200 may include a first blowing part 210 that blows the external air toward the first stage 10 and a second blowing part 220 that blows the external air toward the second stage 20.

The first blowing part 210 may be provided in plurality, and the plurality of first blowing parts 210 may be disposed in parallel with the first stage 10 along a forward and backward direction of the charging and discharging apparatus 1000.

Likewise, the second blowing part 220 may be provided in plurality, and the plurality of second blowing parts 220 may be disposed in parallel with the second stage 20 along the forward and backward direction of the charging and discharging apparatus 1000.

The blowing part 200 may include a motor (not shown) that generates rotational force, a blowing fan 21 connected to a rotation shaft of the motor, and a blowing duct 25 that transfers the external air, which is suctioned through the blowing fan 21, toward the plurality of battery cells 110.

In addition, a central portion of the blowing fan 21 may be coupled to a rotation shaft of the motor. A controller 90, which will be described below, may control an air volume of the blowing part 200. The air volume may be defined as an amount of air that moves per unit time via the blowing fan 21 from one blowing part 200 toward the stage part 100. When the blowing part 200 includes the blowing fan 21, the air volume may be proportional to a rotation speed of the blowing fan 21.

In addition, the charging and discharging apparatus 1000 according to the present disclosure may further include a blowing frame 50 that supports the blowing part 200. Since the blowing part 200 is disposed with the stage part 100 therebetween, the blowing frame 50 may include a first blowing frame 51 disposed at a left side (in an L direction) of the stage part 100 and a second blowing frame 52 disposed at a right side (in an R direction) of the stage part 100.

FIG. 2 is a schematic side view illustrating an example of the stage part according to the present disclosure.

As described above, the stage part 100 may include a plurality of stages 10 and 20 stacked in the height direction of the charging and discharging apparatus 1000. FIG. 2 illustrates two stages, but this is merely an example, and the number of stages is not limited to two.

The stage part 100 may include jigs 101 and 102 that accommodate a plurality of battery groups BG, each of which groups adjacent battery cells 110 among the plurality of battery cells 110, and a temperature sensor part 150 that measures a temperature of an area adjacent to the plurality of battery groups BG.

As another example, the plurality of battery groups BG may be loaded in trays (not shown), respectively, and then accommodated in the stage part 100. In addition, the jigs 101 and 102 may be electrically connected to the battery group BG accommodated in the tray.

The temperature sensor part 150 may be provided in plurality. For example, the plurality of temperature sensor parts 150 may include a first temperature sensor 151, a second temperature sensor 152, a third temperature sensor 153, and a fourth temperature sensor 154, which are disposed to correspond to the plurality of battery groups BG.

The plurality of battery cells 110 may be grouped in the predetermined number with adjacent battery cells 110 to form the plurality of battery groups BG. The plurality of battery groups BG may be respectively accommodated in one of the plurality of stages 10 and 20.

For example, referring to FIG. 2, the first stage 10 and the second stage 20 may accommodate the plurality of battery groups BG.

The stage part 100 may further include jigs 101 and 102 that detachably support the plurality of battery cells 110, respectively. That is, one battery cell 110 may be disposed between the jigs 101 and 102.

The charging and discharging apparatus 1000 according to the present disclosure may further include the temperature sensor part 150 disposed at one side of the plurality of jigs 101 and 102 and configured to measure a temperature of an area adjacent to the plurality of battery cells 110.

For example, the temperature sensor part 150 may include the plurality of temperature sensors 151, 152, 153, and 154. Referring to FIG. 2, each of the stages 10 and 20 may include four battery groups BG, and the plurality of temperature sensors 151, 152, 153, and 154 may be disposed to correspond to each battery group BG of each of the stages 10 and 20. Thus, each battery group BG may correspond to at least one temperature sensor.

FIG. 3 is a control block diagram of the charging and discharging apparatus according to the present disclosure.

Referring to FIGS. 2 and 3, the charging and discharging apparatus 1000 according to the present disclosure may include the charging and discharging channel part 140 electrically connected to the plurality of battery cells 110, the plurality of jigs 101 and 102 that support the plurality of battery cells 110, the temperature sensor part 150 disposed at one side of the plurality of jigs 101 and 102 to measure the temperature of the area adjacent to the plurality of battery cells 110, and the controller 90 that controls the temperature sensor part 150, charges or discharges the plurality of battery cells 110 through the charging and discharging channel part 140, and calculates a charging capacity of each battery cell 110.

In addition, the controller 90 may calculate a modified charging capacity of each battery cell 110 on the basis of the temperature measured through the temperature sensor part 150 and the calculated (or estimated) charging capacity of each battery cell 110 during the charging of each battery cell 110 through the charging and discharging channel part 140.

The controller 90 may charge and discharge the plurality of battery cells 110 accommodated in the stage part 100 through the charging and discharging channel part 140.

The charging and discharging channel part 140 may include a plurality of charging and discharging channels 145 that charge the plurality of battery groups BG each of which is grouped in the preset number among the plurality of battery cells 110.

The controller 90 may charge and discharge each of the plurality of battery groups BG electrically connected to the plurality of charging and discharging channels 145 through the plurality of charging and discharging channels 145.

In addition, the controller 90 may confirm whether charging and discharging of the plurality of battery cells 110 has been completed through the charging and discharging channel part 140, and may acquire the charging capacities of each of the plurality of battery cells 110 through the charging and discharging channel part 140.

The charging capacity refers to an electrical capacity of one battery cell 110 when a state of charge (SOC) of one battery cell 110 is 100%. The controller 90 may confirm the charging capacity of the one battery cell 110 through one charging and discharging channel 145 connected to the one battery cell 110 during the charging or discharging of the one battery cell 110.

When charging and discharging the plurality of battery cells 110, heat may be generated in the plurality of battery cells 110. Thus, in order to manage the heat of the charging and discharging apparatus 1000, the controller 90 may control the blowing part 200.

A method for controlling the charging and discharging apparatus according to the present disclosure relates to a method for correcting charging capacities of the plurality of battery cells 110 calculated by the controller 90 so that the charging capacities of the plurality of battery cells 110 reflect actual charging capacities in consideration of the temperatures of the plurality of battery cells 110 charged/discharged in the charging and discharging apparatus 1000.

Since the plurality of battery cells 110 are divided into the plurality of battery groups BG, and the charging and discharging is performed through the charging and discharging channels 145 corresponding to each battery group BG, the charging and discharging apparatus 1000 may modify (or correct) the charging capacities of the battery cells 110 included in the battery group BG corresponding to one of the charging and discharging channels 145 or may modify (or correct) the correction capacities of the individual battery cells 110.

The controller 90 may control the temperature sensor part 150. The temperature sensor part 150 may include a plurality of temperature sensors 151, 152, 153, and 154 that measure the temperature of the area to which each battery group BG belongs. At least one of the plurality of temperature sensors 151, 152, 153, and 154 may be disposed in each of the plurality of battery groups BG to measure the temperature of the area adjacent to the battery group BG or the temperature of the battery group BG.

More specifically, when charging each battery group BG through the plurality of charging and discharging channels 145, the controller 90 may measure the temperature of the area, to which each battery group BG belongs, through the plurality of temperature sensors 151, 152, 153, and 154.

Here, the temperature of the area to which each battery group BG belongs may be a mean temperature in a preset measurement section when the plurality of battery cells 110 are charged.

The temperature of the area to which each battery group BG belongs may also be a mean temperature over the entire time period during which the plurality of battery cells 110 are charged or discharged. Alternatively, the temperature of the area to which each battery group BG belongs may be a temperature acquired through the plurality of temperature sensors 151, 152, 153, and 154 at a specific time point.

More specifically, the controller 90 may calculate the modified charging capacity of any battery cell 110 of the one battery group BG by using Equation 1 below.

$$ACC = A \times ( capacity ) + B \times ( temperature ) + C \qquad [ Equation 1 ]$$

Here, ACC represents a modified charging capacity of any battery cell, C represents a calculated charging capacity of the any battery cell, T represents a temperature of an area to which one of the battery groups belongs, and A, B, and C represent constants.

According to an embodiment, at least some of a plurality of equations for calculating the specified modified charging capacity for each of the plurality of battery groups BG may be different from each other. That is, the at least some of the plurality of equations may have different values for A, B, and C.

Hereinafter, a method for acquiring the values A, B, and C in Equation 1 will be described.

For example, the values A, B, and C in Equation 1 may be acquired using a specific battery cell of the battery cells 110 included in the same battery group BG grouped in a preset number. The specific battery cell may include a first battery cell, a second battery cell, and a third battery cell. The number of specific battery cells is not limited thereto.

According to an embodiment, a temperature of an area to which the battery group BG belongs may be acquired through the temperature sensor part 150.

According to an embodiment, a charging capacity calculated when charging the first battery cell may be acquired through the charging and discharging channel part 140. According to an embodiment, a battery capacity acquisition device of a laboratory chamber may acquire a battery capacity of the first battery cell.

According to an embodiment, a charging capacity calculated when charging the second battery cell may be acquired through the charging and discharging channel part 140. According to an embodiment, the battery capacity acquisition device of the laboratory chamber may acquire a battery capacity of the second battery cell.

According to an embodiment, a charging capacity calculated when charging the third battery cell may be acquired through the charging and discharging channel part 140. According to an embodiment, the battery capacity acquisition device of the laboratory chamber may acquire a battery capacity of a third battery cell.

According to an embodiment, the controller 90 may acquire the values A, B, and C on the basis of a relationship between the charging capacities acquired through the charging and discharging channel parts 140 of the first battery cell, the second battery cell, and the third battery cell, the battery capacities of the first battery cell, the second battery cell, and the third battery cell acquired in the laboratory chamber, and the temperature of the area to which the battery group BG belongs acquired through the temperature sensor part 150. Here, dependent variables may be the battery capacities acquired from the battery capacity acquisition device of the laboratory chamber. The battery capacity acquired from the battery capacity acquisition device of the laboratory chamber may correspond to a value of ACC in Equation 1. The independent variables may be the charging capacity acquired through the charging and discharging channel part 140 and the temperature. The charging capacity may be a value corresponding to the capacity in Equation 1. The temperature may be a value corresponding to the temperature in Equation 1.

According to an embodiment, the relationship may include a relationship based on a regression model.

For example, the relationship may be based on a coefficient of determination (R², R Square) and/or a mean absolute error MAE.

According to an embodiment, the controller 90 may determine the values A, B, and C so that the value of the coefficient of determination is greater than a preset first value, and the value of the mean absolute error is less than a preset second value. Alternatively, according to an embodiment, the controller 90 may determine the values A, B, and C having the largest value of the coefficient of determination and the smallest value of the mean absolute error.

According to an embodiment, the controller 90 may calculate the modified charging capacity of any battery cell 110 included in one of the battery groups BG on the basis of the determined equation 1 using the following Equation 1.

In addition, the controller 90 may individually control the blowing parts 200 on the basis of the temperature measured by the temperature sensor part 150. This is for managing the temperatures of the plurality of battery cells 110 accommodated in the charging and discharging apparatus 1000.

In addition, the controller 90 may further include a communication part 190 for communicating with another device (e.g., a server).

In addition, the controller 90 may control an input/output part (not shown) that receives a command from a user or displays a performance state and a result of performance.

That is, a charge/discharge system 1 according to the present disclosure may include a charging and discharging channel part 140 electrically connected to a plurality of battery cells 110, a plurality of jigs 101 and 102 that support the plurality of battery cells 110, a temperature sensor part 150 disposed at one side of the plurality of jigs 101 and 102 to measure a temperature of an area adjacent to the plurality of battery cells 110, a controller 90 that controls the temperature sensor part 150, charges or discharges the plurality of battery cells 110 through the charging and discharging channel part 140, and calculates a charging capacity of each battery cell 110, and a server 900 that is capable of communicating with the controller 90. The controller 90 may calculate a modified charging capacity of each battery cell 110 on the basis of the temperature measured by the temperature sensor part 150 and the calculated charging capacity of each battery cell 110 during charging or discharging of the plurality of battery cells 110 through the charging and discharging channel part 140 and may transmit the modified charging capacity to the server.

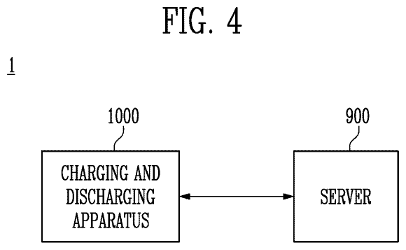

FIG. 4 is a view illustrating an example of the charging and discharging system according to the present disclosure.

As described above, the charging and discharging apparatus 1000 according to the present disclosure may calculate the charging capacities of the plurality of battery cells 110, which are accommodated in the charging and discharging apparatus 1000 and charged/discharged by using the temperature acquired through the temperature sensor part 150, and may modify the calculated charging capacities according to Equation so that the calculated charging capacities match the actual charging capacities.

In addition, information regarding the modified charging capacity may be stored in a server (or management server) that stores information about the plurality of battery cells 110.

For this, the charging and discharging system 1 according to the present disclosure may include the charging and discharging apparatus 1000 and the server 900 that communicates with the charging and discharging apparatus 1000 to store information about the charging capacities of the plurality of battery cells 110 accommodated in the charging and discharging apparatus 1000.

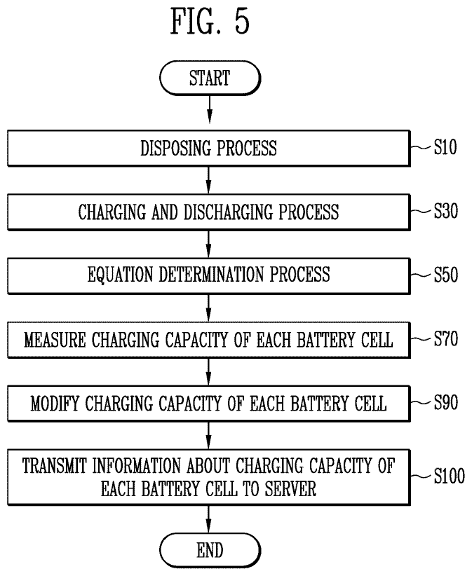

FIG. 5 is a flowchart illustrating a method for controlling a charging and discharging apparatus according to the present disclosure.

A method for controlling the charging and discharging apparatus 1000 according to the present disclosure may include a process (S10) of disposing the plurality of battery cells 110 on the plurality of jigs 101 and 102.

The method for controlling the charging and discharging apparatus 1000 according to the present disclosure may include a process (S30) of charging or discharging each battery cell 110. In the method for controlling the charging and discharging apparatus 1000 according to the present disclosure, each battery cell 110 may be fully charged or discharged through the charging and discharging channel part 140.

In contrast, in the method for controlling the charging and discharging apparatus 1000 according to the present disclosure, each battery cell 110 may be charged to a preset target charging value or discharged to a preset target discharging value through the charging and discharging channel part 140.

The method for controlling the charging and discharging apparatus 1000 according to the present disclosure may include a process (S50) of determining an equation for modifying a charging capacity of each battery group BG. The Equation refers to Equation 2, which will be described below.

Hereinafter, a process of determining an equation for modifying a charging capacity of one battery group of the battery groups BG will be described.

The method for controlling the charging and discharging apparatus 1000 according to the present disclosure may include a process of selecting a specific battery cell from the battery cells 110 included in the one battery group BG. The method for controlling the charging and discharging apparatus 1000 according to the present disclosure may include a process of determining, on the basis of a regression model, an equation for modifying charging capacities of the battery cells 110 included in the one battery group BG, by using a charging capacity of a specific battery cell through the charging and discharging channel part 140, a battery capacity of a specific battery cell acquired in a laboratory chamber, and a temperature of an area to which one of the battery groups belongs.

For example, the regression model may be based on a coefficient of determination (R², R Square) and/or a mean absolute error MAE.

The method for controlling the charging and discharging apparatus 1000 according to the present disclosure may include a process of determining values A, B, and C so that a value of the coefficient of determination is greater than a preset first value, and a value of the mean absolute error is less than a preset second value. Alternatively, in the method for controlling the charging and discharging apparatus 1000 according to the present disclosure, the values A, B, and C having the largest value of the coefficient of determination and the smallest value of the mean absolute error may be determined.

The description of the process of determining the equation for modifying the charging capacity of one battery group of the battery groups BG may be equally applied to the description for the process of determining the equation for modifying the charging capacity of each of the remaining battery groups other than the one battery group.

The method for controlling the charging and discharging apparatus 1000 according to the present disclosure may include a process (S70) of calculating (or estimating) the charging capacities of the plurality of battery cells 110 using the charging and discharging channel part 140.

The method for controlling the charging and discharging apparatus 1000 according to the present disclosure may include a process (S90) of modifying the charging capacity of each battery cell 110. The process of modifying the charging capacity of each battery cell 110 (S90) may include calculating the charging capacity using Equation 2 for each battery group BG to which each battery cell 110 belongs among the battery groups BG. In Equation 2, the values A, B, and C may be different for each battery group BG.

Equation 2 may represent an equation determined in the process (S50) of determining the equation for each battery group BG.

$$ACC = A \times ( capacity ) + B \times ( temperature ) + C \qquad [ Equation 2 ]$$

Here, ACC represents a modified charging capacity of any battery cell, C represents a calculated charging capacity of the any battery cell, T represents a temperature of an area to which one of the battery groups belongs, and A, B, and C represent constants.

The temperature of the area to which one of the battery groups belongs may be a mean temperature in a preset measurement section when charging the plurality of battery cells included in the one battery group.

The method for controlling the charging and discharging apparatus 1000 according to the present disclosure may include a process (S100) transmitting, to a server 900 capable of communicating with the charging and discharging apparatus 1000, the modified charging capacities (information on the charging capacities) of the battery cells 110 after the process (S90) of modifying the charging capacities of the battery cells 110.

As a result, the charging capacities of the plurality of battery cells 110 charged/discharged by the charging and discharging apparatus 1000 may be updated to the modified charging capacities and may be managed by the server 900.

According to the embodiment of the present disclosure, the manufacturing efficiency of the battery cell may be improved.

According to another embodiment of the present disclosure, the failure rate of the battery cell may be reduced.

According to further another embodiment of the present disclosure, the quality of the battery cell may be improved.

The above description is merely an example that applies the principles of the present disclosure, and other configurations may be included without departing from the scope of the present invention.

What is claimed is:

1. A charging and discharging apparatus comprising:
a charging and discharging channel part electrically connected to a plurality of battery cells;
a plurality of jigs configured to support the plurality of battery cells;
a temperature sensor part disposed at one side of the plurality of jigs to measure a temperature of an area adjacent to the plurality of battery cells; and
a controller configured to control the temperature sensor part, charge or discharge the plurality of battery cells through the charging and discharging channel part, and measure a charging capacity of each battery cell,
wherein the controller is configured to calculate a modified charging capacity of each battery cell using a preset equation on the basis of the temperature measured through the temperature sensor part and the calculated charging capacity of each battery cell when each battery cell is charged through the charging and discharging channel part.

2. The charging and discharging apparatus of claim 1, wherein the charging and discharging channel part comprises a plurality of charging and discharging channels configured to charge each of a plurality of battery groups, each of which is grouped by a preset number, among the plurality of battery cells.

3. The charging and discharging apparatus of claim 2, wherein the preset equation comprises a plurality of preset equations for each of the plurality of battery groups,
wherein at least some of the plurality of preset equations are different from each other.

4. The charging and discharging apparatus of claim 2, wherein the temperature sensor part comprises a plurality of temperature sensors configured to measure a temperature of an area to which each battery group belongs.

5. The charging and discharging apparatus of claim 4, wherein the controller is configured to calculate a modified charging capacity of any battery cell in one battery group by following Equation 1 representing the preset equation;
$$ACC = A \times ( capacity ) + B \times ( temperature ) + C \qquad [ Equation 1 ]$$
Here, ACC represents the modified charge capacity of any battery cell, C represents the calculated charge capacity of the any battery cell, T represents the temperature of the area to which the one battery group belongs, and A, B, and C represent constants.

6. The charging and discharging apparatus of claim 4, wherein the temperature of the area to which each battery cell belongs is a mean temperature in a preset measurement section when charging the plurality of battery cells.

7. A charging and discharging apparatus comprising:
a charging and discharging channel part electrically connected to a plurality of battery cells;
a plurality of jigs configured to support the plurality of battery cells;
a temperature sensor part disposed at one side of the plurality of jigs to measure a temperature of an area adjacent to the plurality of battery cells;
a controller configured to control the temperature sensor part, charge or discharge the plurality of battery cells through the charging and discharging channel part, and calculate a charging capacity of each battery cell; and
a server configured to communicate with the controller,
wherein the controller is configured to calculate a modified charging capacity of each battery cell using a preset equation on the basis of the temperature measured through the temperature sensor part and the calculated charging capacity of each battery cell when the plurality of battery cells are charged through the charging and discharging channel part so as to transmit the calculated modified charging capacity to the server.

8. A method for controlling a charging and discharging apparatus, the method comprising:
a process of charging or discharging each of battery cells through a charging and discharging channel part electrically connected to the plurality of battery cells;
a process of calculating a charging capacity of each battery cell during the charging of each battery cell through the charging and discharging channel part on the basis of the temperature measured by the temperature sensor part, which is disposed at one side of a plurality of jigs that support the plurality of battery cells to measure a temperature of an area adjacent to the plurality of battery cells; and
a process of modifying the charging capacity of each battery cell using a preset equation on the basis of the temperature and the calculated charging capacity of each battery cell.

9. The method of claim 8, further comprising, before the process of charging and discharging each battery cell, a process of disposing the plurality of battery cells on the plurality of jigs.

10. The method of claim 9, further comprising, after the process of modifying the charging capacity of each battery cell, a process of transmitting the modified charging capacity of each battery cell to a server communicating with the charging and discharging apparatus.

11. The method of claim 8, wherein the process of modifying the charging capacity of each battery cell comprises a process of calculating a modified charging capacity of any battery cell in one battery group using following Equation 2;
$$ACC = A \times ( capacity ) + B \times ( temperature ) + C \qquad [ Equation 2 ]$$
Here, ACC represents a modified charge capacity of any battery cell, C represents a calculated charge capacity of the any battery cell, T represents a temperature of an area to which one of the battery groups belongs, and A, B, and C represent constants.

12. The method of claim 11, wherein, in the process of modifying the charging capacity of each battery cell, the temperature of the area to which each battery group belongs is a mean temperature in a preset measurement section when charging the plurality of battery cells.
